(19) United States
(12) Patent Application Publication
(10) Pub. No.: US 2010/0067712 A1
(43) Pub. Date: Mar. 18, 2010

(54) Echo Cancelling Device, Signal Processing Device and Method Thereof, and Program

(76) Inventor: Yuuji MAEDA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/558,011

(22) Filed: Sep. 11, 2009

(30) Foreign Application Priority Data
Sep. 12, 2008 (JP) P2008-235433

(51) Int. Cl. H04B 3/20

(52) U.S. Cl. 381/66

(57) ABSTRACT

An echo cancelling device includes a filter-coefficient polarity inverter configured to invert the polarity of a filter coefficient at intervals of a predetermined frame length, an adaptive filter configured to estimate a signal to be inputted from an unknown system by multiplying a signal to be outputted from a speaker by the filter coefficient, and generate the resultant estimated signal, a subtracter configured to calculate an error signal from an input signal from a microphone and the estimated signal, and an error-signal polarity inverter configured to invert the polarity of the error signal in synchronization with the inversion of the polarity of the filter coefficient at intervals of the predetermined frame length. The adaptive filter updates the filter coefficient on the basis of the error signal by using binary fixed-point arithmetic, and therein, performing a truncation operation.

### BACKGROUND OF THE INVENTION

1. Field of the Invention

The present invention relates to an echo cancelling device, a signal processing device and a method therefor, and a program, which use binary fixed-point arithmetic.

2. Description of the Related Art

At present, digital devices, such as voice communication devices and computers, include large scale integrated chips (LSI) chips. The LSI chips are roughly classified into two types, one being a binary fixed-point arithmetic type, the other one being a floating-point arithmetic type. The floating-arithmetic type has characteristics in that it allows variables to be expressed in floating-point format and thus enables suppression of the occurrence of arithmetic errors, but incurs relatively high power consumption and cost. In contrast, the binary fixed-point arithmetic type has characteristics in that it allows variables to be expressed in binary fixed-point format (i.e., in integer format) and incurs relatively low power consumption and cost, but can negligibly avoid suppression of the occurrence of arithmetic errors.

In general, voice communication devices sometimes have to incorporate an echo canceller therein in order to cancel echo signals due to signals originating from a speaker and returning to a microphone. The echo canceller adaptively estimates an echo path from signals to be outputted from the speaker and signals being inputted from the microphone, further, generates pseudo echo signals by multiplying adaptive-filter coefficients, which are updated on the basis of the estimation, by the signals to be outputted from the speaker, and cancels the echo signals by subtracting the pseudo echo signals from the signals being inputted from the microphone. With respect to the update of the adaptive-filter coefficients, for example, in the case where the least mean squares (LMS) method is employed, the update is performed every time sampling of the signals inputted from the microphone is performed, by using the following formula (1):

[Number 1]

H(n+1)=H(n)+2με(n)X(n) (1)

Here, n is a sampling number. Further, H(n) and X(n) are an adaptive-filter coefficient and a signal to be outputted from a speaker, respectively, and are both vector quantities. Furthermore, μ is a step size, and ε(n) is a residual echo signal.

In Japanese Unexamined Patent Application Publication No. Hei 2-58916, adaptive-filter processing performed by using a processor incorporating a floating-point arithmetic circuit therein is disclosed. However, in portable communication terminals, such as handsfree telephones, the reduction of power consumption is necessary, and thus, the usage of a processor incorporating therein only a binary fixed-point arithmetic circuit with low electric power consumption is more reasonable than the usage of a processor incorporating therein a floating-point arithmetic circuit which usually consumes a large amount of electric power.

### SUMMARY OF THE INVENTION

In the case where the foregoing adaptive-filter process, such as an echo cancelling process, is performed, the update of adaptive-filter coefficients performed every time sampling is performed takes a large number of arithmetic operations. Further, more particularly, in the case where the update of adaptive-filter coefficients is performed by using binary fixed-point arithmetic, it is difficult to avoid occurrence of arithmetic errors in the update of adaptive-filter coefficients. In the update of adaptive-filter coefficients, performing arithmetic rounding operations so as to reduce the arithmetic errors leads to an increase of the number of arithmetic operations to an unignorable degree.

More specifically, multiplication operations are performed with respect to a second term of the right-hand side in the above-described formula (1), and in the case where the multiplication operations are performed by using the binary fixed-point arithmetic, individual arithmetic rounding operations performed with respect to lower bits of the multiplication results lead to an increase of the number of arithmetic operations. In contrast, truncation operations performed with respect to lower bits leads to a reduction of the number of arithmetic operations, but constantly cause arithmetic errors in a negative direction when generating the active-filter coefficients, and as a result, bring adverse effects on a convergence characteristic of the adaptive filter.

Accordingly, it is desirable to provide a signal processing device and a method therefor, and a program, which enable reduction of the number of arithmetic operations, and further, prevention of adverse effects due to arithmetic errors.

An echo cancelling device according to an embodiment of the present invention includes a filter-coefficient polarity inverter configured to invert the polarity of a filter coefficient at intervals of a predetermined frame length, an adaptive filter configured to estimate a signal to be inputted from an unknown system by multiplying a signal to be outputted from a speaker by the filter coefficient, and generate the resultant estimated signal, a subtracter configured to calculate an error signal from an input signal from a microphone and the estimated signal, and an error-signal polarity inverter configured to invert the polarity of the error signal in synchronization with the inversion of the polarity of the filter coefficient at intervals of the predetermined frame length, wherein the adaptive filter updates the filter coefficient on the basis of the error signal by using binary fixed-point arithmetic, and therein, performing a truncation operation.

Further, a signal processing device according to an embodiment of the present invention includes a filter-coefficient polarity inverter configured to invert the polarity of a filter coefficient at intervals of a predetermined frame length, an adaptive filter configured to estimate a signal to be outputted from an unknown system by multiplying an input signal to the unknown system by the filter coefficient, and generate the resultant estimated signal, a subtracter configured to calculate an error signal from an outputting signal from the unknown system and the estimated signal, and an error-signal polarity inverter configured to invert the polarity of the error signal in synchronization with the inversion of the polarity of the filter coefficient at intervals of the predetermined frame length, wherein the adaptive filter updates the filter coefficient on the basis of the error signal by using binary fixed-point arithmetic, and therein, performing a truncation operation.

Further, a signal processing method according to an embodiment of the present invention includes the steps of inverting the polarity of a filter-coefficient at intervals of a predetermined frame length, generating an estimated signal resulting from estimation of a signal to be outputted from an unknown system by multiplying an input signal to the unknown system by the filter coefficient, performing subtraction to calculate an error signal from an outputting signal from the unknown system and the estimated signal, inverting the polarity of the error signal in synchronization with the inversion of the polarity of the filter coefficient at intervals of the predetermined frame length, and updating the filter coefficient on the basis of the error signal by using binary fixed-point arithmetic, and therein, performing a truncation operation.

Further, a program according to an embodiment of the present invention is configured to cause an information processing device to execute the steps of inverting the polarity of a filter-coefficient at intervals of a predetermined frame length, generating an estimated signal resulting from estimation of a signal to be outputted from an unknown system by multiplying an input signal to the unknown system by the filter coefficient, performing subtraction to calculate an error signal from an outputting signal from the unknown system and the estimated signal, inverting the polarity of the error signal in synchronization with the inversion of the polarity of the filter coefficient at intervals of the predetermined frame length, and updating the filter coefficient on the basis of the error signal by using binary fixed-point arithmetic, and therein, performing a truncation operation.

According to an embodiment of the present invention, it is possible to reduce the number of arithmetic operations by inverting the polarities of filter coefficients at intervals of a predetermined frame length, and further, removing arithmetic rounding operations and performing truncation operations in binary fixed-point arithmetic. Further, it is possible to prevent adverse effects due to occurrence of arithmetic errors by updating the filter coefficients by means of inversion of the polarities of the filter coefficients and the polarities of the error signals in synchronization with the inversion of the polarities of the filter coefficients performed at intervals of the predetermined frame length.

### BRIEF DESCRIPTION OF THE DRAWINGS

FIG. 1 is a block diagram of a configuration of an echo canceller in general use;

FIG. 2 is a diagram illustrating a result of an impulse response with respect to an echo path used in a simulation;

FIG. 3 is a diagram illustrating an adapting process of an adaptive-filter coefficient h⁽ⁿ⁾(13) according to a method used in an adaptive filter in general use;

FIG. 4 is a block diagram of a configuration of an echo canceller according to an embodiment of the present invention;

FIG. 5 is a diagram illustrating an adapting process of an adaptive-filter coefficient h⁽ⁿ⁾(13) according to a method used in an embodiment of the present invention;

FIG. 6 is a diagram illustrating a calculation result of echo return loss enhancement (ERLE) for each frame; and

FIG. 7 is a flowchart illustrating arithmetic processes of an echo canceller according to an embodiment of the present invention.

### DESCRIPTION OF THE PREFERRED EMBODIMENTS

Hereinafter, a specific example of an embodiment according to the present invention will be described in detail with reference to drawings. In this embodiment, the present invention is applied to echo canceller. Firstly, a general-use echo canceller will be described, and secondly, an echo canceller according to an embodiment of the present invention will be described.

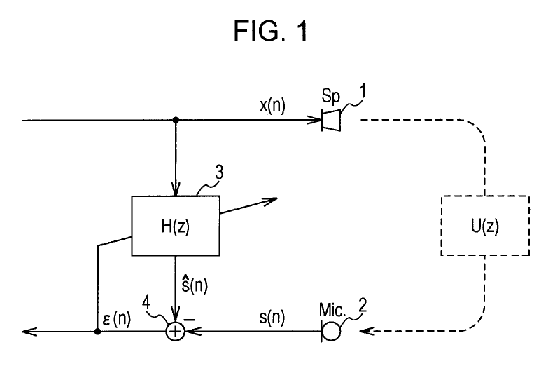

1. A general-use echo canceller FIGS. 1 to 3

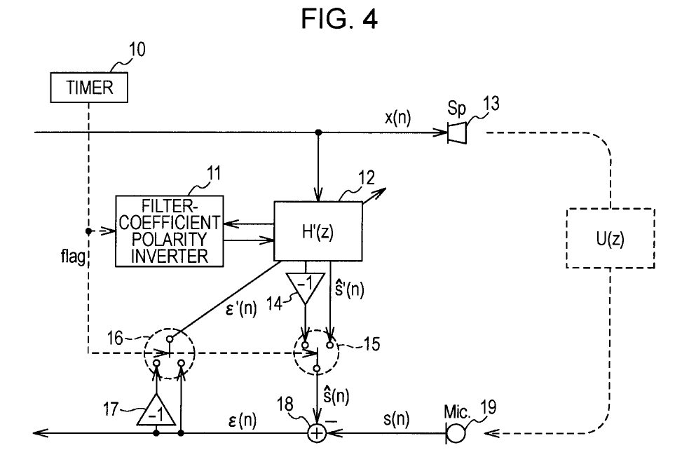

2. An echo canceller according to an embodiment of the present invention FIGS. 4 to 7

[1. An Echo Canceller in General Use]

FIG. 1 is a block diagram illustrating a configuration of an echo canceller in general use. This echo canceller includes a speaker (SP) 1, a microphone (Mic.) 2, an adaptive filter 3 and an adder 4. The adaptive filter 3 performs multiplication of an output x(n) to the speaker 1 by an adaptive-filter coefficient H(z) resulting from estimation of an impulse-response characteristic of an echo, and as a result, outputs a pseudo echo signal ŝ(n). Further, the adder 4 performs subtraction of the pseudo echo signal ŝ(n) from an echo signal s(n) inputting from the microphone 2, and outputs the resultant signal, i.e., a residual echo signal ε(n).

Subsequently, specific arithmetic processes performed by the echo canceller will be described.

The output x(n) to the speaker (SP) 1 is returned to the microphone (Mic.) 2 as the echo signal s(n) via a transmission characteristic U(z) of an unknown echo, as represented by the following formula:

$$\begin{matrix}[ Number 2 ] & \\ s ( n ) = {\sum }_{i = 0}^{∞} u ( i ) ( n - i ) & ( 2 )\end{matrix}$$

The adaptive filter 3 generates the pseudo echo signal ŝ(n) by multiplying the output x(n) to the speaker by the characteristic of the adaptive filter H(z), that is, the adaptive-filter coefficient resulting from estimation of an impulse response characteristic of the echo, as represented by the following formula:

$$\begin{matrix}[ Number 3 ] & \\ \hat{s} ( n ) = {\sum }_{i = 0}^{N - 1} {h}^{( n )} ( i ) x ( n - i ) & ( 3 )\end{matrix}$$

Here, N is the number of taps of the adaptive filter 3.

The adder 4 generates the residual echo signal ε(n) by subtracting the pseudo echo signal ŝ(n) from the echo signal s(n) being input from the microphone 2, as represented by the following formula:

[Number 4]

ε(n)=s(n)−ŝ(n) (4)

Provided that the adaptive filter 3 can appropriately estimate the transmission characteristic of the echo, as a result, the residual echo signal ε(n) can be suppressed. In order to estimate the transmission characteristic of the echo, the normalized least mean squares method (normalized LMS method) is widely used.

In the normalized LMS method, the adaptive filter coefficients are updated by using the following formula:

$$\begin{matrix}[ Number 5 ] & \\ {h}^{( n + 1 )} ( i ) = {h}^{( n )} ( i ) + \frac{μ ɛ ( n ) \times ( n - i )}{N \cdot {σ ( n )}^{2}} ( i = 0 … N - 1 ) & ( 5 )\end{matrix}$$

The denominator σ(n)² in the second term of the right-hand side of the formula (5) represents the smoothed electric power of the signals outputted to the speaker, and is updated by using the following formula:

[Number 6]

σ(n)²=(1−η)·σ(n−1)²+η·x(n)² (6)

Here, η is a smoothing coefficient.

In the case where the above-described formula (5) is calculated by using binary fixed-point arithmetic, a part of the second term of the right-hand side in the formula (5) is constant regardless of the value of i, and this part can be replaced by α, as represented by the following formula:

$$\begin{matrix}[ Number 7 ] & \\ α = \frac{μ ɛ ( n )}{N \cdot {σ ( n )}^{2}} & ( 7 )\end{matrix}$$

Here, in order to perform adjustment of scaling in each multiplication operation in the formulae (5) and (7), an arithmetic right-shifting operation by the number of shifting bits (which is denoted by “SHIFT”) is performed, and concurrently, an arithmetic rounding operation is performed by adding a rounding value (which is denoted by “ROUND”) to the multiplication result, as represented by the following formula:

[Number 8]

h⁽ⁿ⁺¹⁾(i)=h⁽ⁿ⁾(i)+((α·x(n−i)+ROUND)>>SHIFT) (i=0 . . . N−1) (8)

Here, the rounding value ROUND is represented as follows:

[Number 9]

ROUND=1<<(SHIFT−1) (9)

Here, taking into account the necessity of updates of all filter coefficients performed every time sampling is performed, the number of arithmetic operations with respect to addition of the rounding value ROUND is not so small. Therefore, the removal of the addition of the rounding value ROUND from the formula (8) results in the following formula:

[Number 10]

h⁽ⁿ⁺¹⁾(i)=h⁽ⁿ⁾(i)+((α·x(n−i))>>SHIFT) (i=0 . . . N−1) (10)

In this formula, in the second term of the right-hand side, a truncation operation is performed with respect to lower bits, and thus, considering that the lower bits represent a value after the decimal point, an arithmetic error occurs every time the update of the filter coefficients is performed, the arithmetic error being uniformly distributed within the range between “0” and “1”.

Here, let us denote this arithmetic error term by δ(n), and then, an accumulated arithmetic error can be represented as follows:

$$\begin{matrix}[ Number 11 ] & \\ {\sum }_{m = 0}^{n} δ ( m ) \to 0.5 \cdot n & ( 11 )\end{matrix}$$

Consequently, an accumulated arithmetic error resulting from multiplication of the number of updates of the adaptive-filter coefficients “n” by a constant value “0.5” occurs every time sampling is performed.

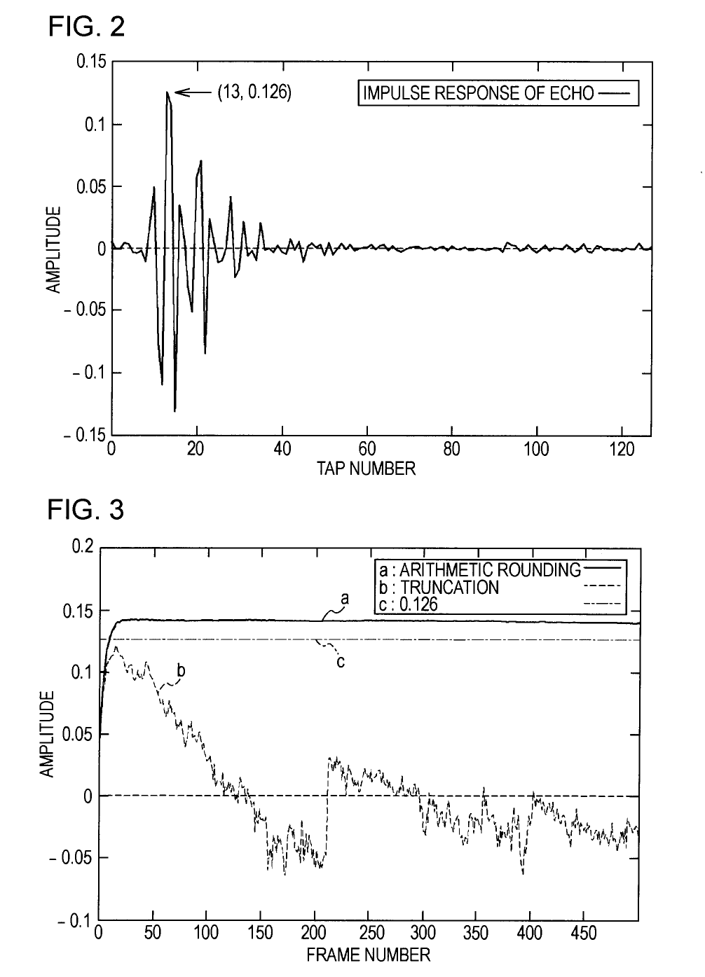

Next, an arithmetic error will be described by using a result of a simulation. FIG. 2 is a diagram illustrating a result of an impulse response of an echo path used in a simulation. In addition, the number of taps is limited to 128. Assuming that the impulse response shown in FIG. 2 represents the unknown transmission characteristic U(z) of an echo, the echo signal s(n) is derived from the formula (2).

FIG. 3 is a diagram illustrating an adapting process with respect to an adaptive-filter coefficient h⁽ⁿ⁾(13) . This adapting process with respect to the adaptive-filter coefficient h⁽ⁿ⁾(13) represents an adapting process, being associated with a tap having a number 13 in the impulse response of an echo shown in FIG. 2 (a position indicated by an arrow in FIG. 2), and resulting from estimation from the echo signal s(n) and the signal x(n) outputted to the speaker by using the formula (3), (8) and (10). In FIG. 3, a vertical axis represents values resulting from division of amplitude values expressed in binary fixpoint form by a value “32768”, that is, a value in Q15 format. A horizontal axis represents frame numbers in place of sampling numbers, the frame numbers each being the number of a frame which is defined as a group of 160 samples.

In FIG. 3, a solid line “a” shows values of the adaptive filter coefficient h⁽ⁿ⁾(13) estimated by the formula (8), which are higher than a true value “c”, i.e., “0.126”, but represents a stable estimated value. In contrast, a dotted line “b” shows values resulting from estimation by truncation operations performed in such a way as represented in the formula (10), and in an earlier stage, effects resulting from the estimation can be seen; however, adverse effects due to arithmetic errors gradually occur, and finally, the adaptation results in a collapse.

[2. An Echo Canceller According to an Embodiment of the Present Invention]

An echo canceller according to an embodiment of the present invention includes a method in which, the polarities of the adaptive-filter coefficients are inverted at intervals of a constant period, and further, when performing updating operations with respect to adaptive-filter coefficients every time sampling is performed, arithmetic rounding operations are not performed, but truncation operations are performed. This method enables practical cancellation of influences due to truncation operations performed in binary fixed-point arithmetic, and further, reduction of the number of arithmetic operations.

FIG. 4 is a block diagram illustrating a configuration of an echo canceller according to an embodiment of the present invention. This echo canceller includes a timer 10, a filter-coefficient polarity inverter 11, an adaptive filter 12, a speaker (SP) 13, a first multiplier 14, a first switch 15, a second switch 16, a second multiplier 17, an adder 18 and a microphone (Mic.) 19.

The timer 10 transmits a signal (flag) at intervals of a period of NF samples which corresponds to one frame. Upon receipt of the signal transmitted from the timer 10, the filter-coefficient polarity inverter 11 fetches an adaptive-filter coefficient h′⁽ⁿ⁾(i), inverts the polarity thereof, and returns the resultant adaptive-filter coefficient h′⁽ⁿ⁾(i) to the adaptive filter 12. The adaptive filter 12 generates a tentative pseudo echo signal ŝ′(n), which is an estimated signal resulting from multiplication of the signal x(n) outputted to the speaker by the adaptive-filter coefficients h′⁽ⁿ⁾(i), and concurrently, updates the adaptive-filter coefficients. The first multiplier 14 performs multiplication of the tentative pseudo echo signal ŝ′(n) by a value “−1”, and thereby, inverts the polarity of the tentative pseudo echo signal ŝ′(n). The first switch 15 selects one of two input signals to be outputted as the pseudo echo signal ŝ(n) by switching in accordance with the signal (flag) from the timer 10. The second switch 16 selects one of two input signals to be outputted as the ε′(n) by performing a switching operation in accordance with the signal (flag) from the timer 10. The second multiplier 17 performs multiplication of the residual echo signal ε(n) by a value “−1”, and thereby, inverts the polarity of the residual echo signal ε(n). The adder 18 performs subtraction of the pseudo echo signal ŝ(n) from the echo signal s(n), and thereby, generates the residual echo signal ε(n).

Subsequently, specific arithmetic processes of an echo canceller will be described below. Here, the echo signal s(n) and the signal x(n) outputted to the speaker 13 are divided at intervals of a group of NF sampling timings corresponding to one frame so as to be handled on a frame-by-frame basis, respectively. Further, the frames are classified into two classes of frames, one class including odd numbered frames, the other class including even numbered frames, and further, in place of the adaptive-filter coefficient h⁽ⁿ⁾(i) of the formula (3), a converted adaptive-filter coefficient h′⁽ⁿ⁾(i) is used. The polarity of this adaptive-filter coefficient h′⁽ⁿ⁾(i) is inverted once at each commencement of the frames by the filter-coefficient polarity inverter 11, as represented as follows:

[Number 12]

h′⁽ⁿ⁾(i)=−h′⁽ⁿ⁾(i) (i=0 . . . N−1) (12)

By replacing the adaptive-filter coefficient h⁽ⁿ⁾(i) in the formula (3) with the above-described h′⁽ⁿ⁾(i), the tentative pseudo echo signal ŝ′(n) can be obtained as follows:

$$\begin{matrix}[ Number 13 ] & \\ {\hat{s}}^{′} ( n ) = {\sum }_{i = 0}^{N - 1} {h}^{′ ( n )} ( i ) \times ( n - i ) & ( 13 )\end{matrix}$$

Each of the polarities of the adaptive-filter coefficients obtained during the odd numbered frames and each of the polarities of the adaptive-filter coefficients obtained during the even numbered frames are inverted relative to each other, and here, assuming that the polarities of the adaptive-filter coefficients during the odd numbered frames are inverted to negative ones, the pseudo echo signal ŝ(n) during the odd numbered frames is obtained by multiplication of the tentative pseudo echo signal ŝ′(n) by “−1”, as represented by the following formula:

$$\begin{matrix}[ Number 14 ] & \\ \hat{s} ( n ) = \{ \begin{matrix}{\hat{s}}^{′} ( n ) & even \cdot frame \\ - {\hat{s}}^{′} ( n ) & odd \cdot frame\end{matrix} & ( 14 )\end{matrix}$$

From this formula (14) and the above-described formula (4), the residual echo signal ε(n) is obtained.

Further, the residual echo signal ε′(n) used for updating the adaptive-filter coefficients is converted as represented by the following formula:

$$\begin{matrix}[ Number 15 ] & \\ {ɛ}^{′} ( n ) = \{ \begin{matrix}ɛ ( n ) & even \cdot frame \\ - ɛ ( n ) & odd \cdot frame\end{matrix} & ( 15 )\end{matrix}$$

Further, a constant value used for updating the taps is obtained in a way similar to that for the formula (7), as follows:

$$\begin{matrix}[ Number 16 ] & \\ α = \frac{μ {ɛ}^{′} ( n )}{N \cdot {σ ( n )}^{2}} & ( 16 )\end{matrix}$$

Furthermore, adaptive-filter coefficients are updated in a way similar to that for the formula (10), as follows:

[Number 17]

h′⁽ⁿ⁺¹⁾(i)=h′⁽ⁿ⁾(i)+((α·x(n−i))>>SHIFT) (i=0 . . . N−1) (17)

Here, a reason why, in the above-described formula, performing arithmetic operations is unnecessary but just performing truncation operations is necessary will be described. With respect to estimated adaptive-filter coefficients, during each of the even numbered frames, the value of an arithmetic error arising every time the update of the adaptive-filter coefficients is performed is uniformly distributed within the range between “0” and “1”, whilst, during each of the odd numbered frames, the polarities of the adaptive-filter coefficients are inverted to negative ones, and further, performing truncation operations in binary fixed-point arithmetic is practically identical to performing operations in the round-floor mode, and thus, the value of an arithmetic error arising every time the update of the adaptive-filter coefficients is performed is uniformly distributed within the range between “−1” and “0”. From a long-term viewpoint, the repetition of these operations leads to a uniform distribution of the arithmetic errors within the range between “−1” and “1”, and assuming that an arithmetic-error term arising every time sampling is performed is denoted by δ′(n), the absolute value of the accumulated amount of the arithmetic errors is represented by the following formula (18), and fluctuates within the range whose maximum value is at most less than NF.

$$\begin{matrix}[ Number 18 ] & \\ \vert {\sum }_{m = 0}^{n} {δ}^{′} ( m ) \vert < NF & ( 18 )\end{matrix}$$

Next, arithmetic errors resulting from the above-described method according to an embodiment of the present invention will be described by using a simulation result. This simulation was performed by using the impulse response of an echo shown in FIG. 2 in the same way as the foregoing simulation.

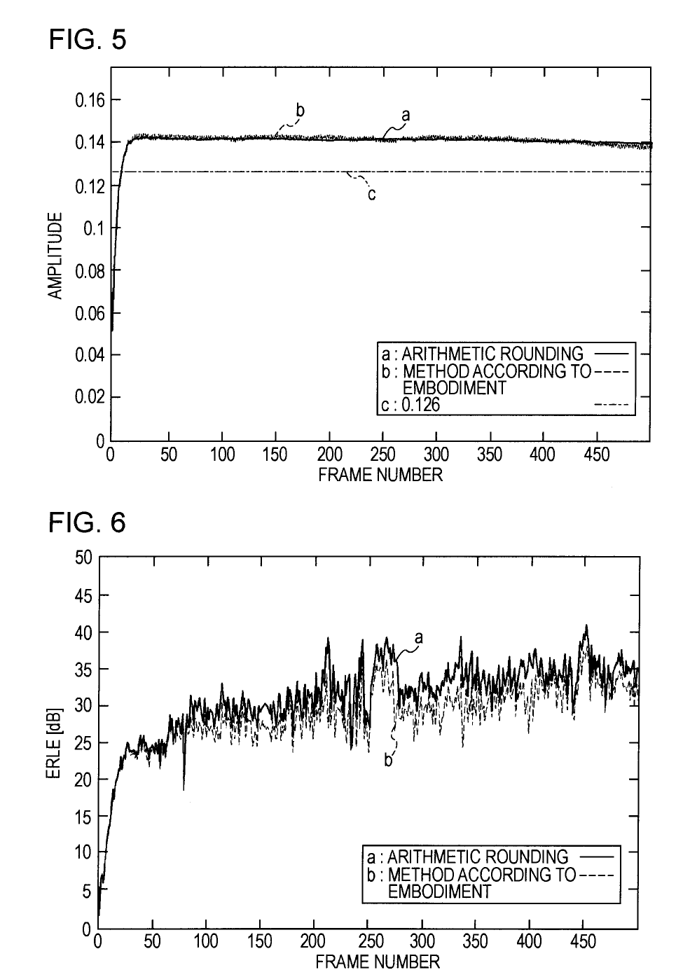

FIG. 5 is a diagram illustrating an adapting process with respect to an adaptive-filter coefficient h⁽ⁿ⁾(13), resulting from a method according to an embodiment of the present invention. In addition, the polarities of the adaptive-filter coefficients during odd numbered frames are subjected to multiplication by a value “−1”. In FIG. 5, a solid line “a” denotes the adapting process with respect to the adaptive filter coefficient h⁽ⁿ⁾(13), resulting from a method using arithmetic rounding operations, and a dotted line “b” denotes the adapting process with respect to the adaptive filter coefficient h⁽ⁿ⁾(13), resulting from the above-described method according to this embodiment. It can be understood from these lines that the adapting process resulting from the above-described method of this embodiment fluctuates to a certain degree, but follows an adapting process approximately the same as that resulting from a method using arithmetic rounding operations.

FIG. 6 is a diagram illustrating values resulting from calculation of echo return loss enhancement (ERLE) for each frame as a performance evaluation of the above-described method according to this embodiment. In addition, the ERLE is defined by the following formula:

$$\begin{matrix}[ Number 19 ] & \\ ERLE [ dB ] = 10 ⋆ {log}_{10} ( \frac{1.0 + {\sum }_{k = 0}^{NF - 1} {s ( k )}^{2}}{1.0 + {\sum }_{k = 0}^{NF - 1} {ɛ ( k )}^{2}} ) & ( 19 )\end{matrix}$$

It can be understood from this formula (9) that the ERLE is a signal power ratio of the echo signal relative to the residual echo signal, and a higher value of the ERLE represents a larger amount of echo cancellation.

In FIG. 6, a solid line “a” denotes values of the ERLE resulting from a method using arithmetic rounding operations, and a dotted line “b” denotes values of the ERLE resulting from the above-described method according to this embodiment. It can be understood from these lines that both ERLE values are approximately the same, and further, are constantly more than 25 dB, thus achieving a satisfactory result.

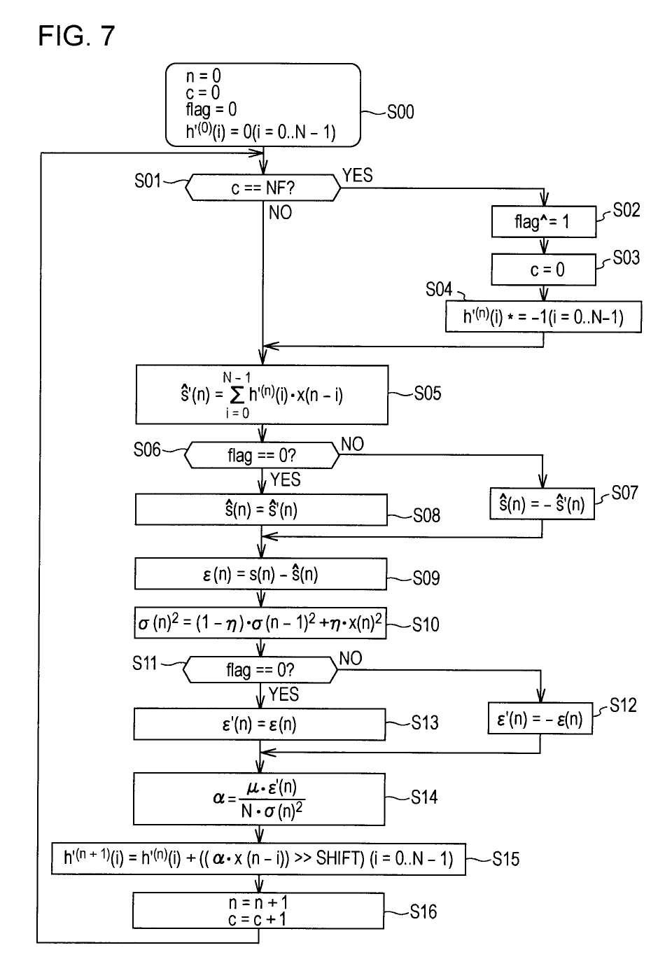

Next, arithmetic processes with respect to an echo canceller according to an embodiment of the present invention will be described with reference to a flowchart shown in FIG. 7. Here, “n” is a sampling number, and “c” is a sampling number within each frame.

During step 500, a controller of the echo canceller performs initialization of the sampling number “n”, the sampling number “c” within each frame, i.e., a value of a counter “c” of the timer 10, a polarity flag and all adaptive-filter coefficients h′⁽⁰⁾(i)(i=0 . . . N−1) by setting a value “0” to these elements.

During step S01, the timer 10 determines whether the value of the counter “c” is equal to NF which is a maximum number of samples within each frame, or not. In the case where the value of the counter “c” is equal to NF, the flow proceeds to step S02, and in the case where the value of the counter “c” is not equal to NF, the flow proceeds to step S05.

During step S02, the timer 10 inverts the polarity flag to “1”, and subsequently, resets the value of the counter “c” to “0” during step S03.

During step S04, upon detection of the inversion of the polarity flag, the filter-coefficient polarity inverter 11 inverts the polarities of all adaptive-filter coefficients, and then, the flow proceeds to step S05.

During step S05, the adaptive filter 12 generates a tentative pseudo echo signal ŝ′(n).

During step S06, the first switch 15 determines whether the polarity flag is “0”, or not. In the case where the polarity flag is not “0”, the flow proceeds to step S07, and in the case where the polarity flag is “0”, the flow proceeds to step S08.

During step S07, since the polarities of the adaptive-filter coefficients h′(n)(i) are inverted to negative ones, the first switch 15 selects the output of the multiplier 14 and outputs a pseudo echo signal ŝ(n) resulting from inversion of the polarity of the tentative pseudo echo signal ŝ′(n).

During step S08, since the polarities of the adaptive-filter coefficients h′(n)(i) are not inverted to negative ones, the first switch selects the output of the adaptive filter 12, and substitutes the tentative pseudo echo signal ŝ′(n) for the pseudo echo signal ŝ(n).

During step S09, the adder 18 performs arithmetic subtraction of the pseudo echo signal ŝ(n) from the echo signal s(n) input from the microphone 19 to generate a residual echo signal ε(n).

During step 510, in order to update the adaptive-filter coefficients, the adaptive filter 12 updates smoothed signal power σ(n)² of a signal outputted to the speaker.

During step S11, the second switch 16 determines whether the flag is “0”, or not. In the case where the flag is not “0”, the flow proceeds to step S12, and in the case where the flag is “0”, the flow proceeds to step S13.

During step S12, the second switch 16 selects the output of the multiplier 17, and outputs a coefficient updating residual echo signal ε′(n) resulting from inversion of the polarity of the residual echo signal ε(n).

During step S13, the second switch 16 selects the output of the adder 18, and substitutes the residual echo signal ε(n) for the coefficient updating residual echo signal ε′(n).

During step S14, the adaptive filter 12 calculates a value α, which is common to all taps.

During step S15, the adaptive filter 12 updates adaptive-filter coefficients by performing truncation operations.

During step S16, the timer 10 increments each of the sampling number “n” and the value of the counter “c” by one, and then, the flow returns to step S01.

As described above, such a method according to this embodiment enables usage of a processor incorporating therein only a binary fixed-point arithmetic circuit. Further, the usage of the processor incorporating therein only a binary fixed-point arithmetic circuit enables reduction of electric power consumption to a greater degree than the usage of a processor incorporating therein a floating-point arithmetic circuit which usually consumes a large amount of electric power.

Furthermore, the inversion of the polarities of coefficients of an adaptive filter incorporated in an echo canceller performed on a frame-by-frame basis enables realization of the reduction of the number of arithmetic operations for the inversion thereof to a greater degree than the inversion of the polarities of coefficients of the adaptive filter performed on a sampling-by-sampling basis.

Further, the inversion of the polarities of the adaptive-filter coefficients performed on a frame-by-frame basis allows a convergence characteristic to be equal to that of the case where the inversion of the polarities of the adaptive-filter coefficients is performed on a sampling-by-sampling basis. For example, assuming that a sampling frequency fs is 8 kHz, further, the polarities of the adaptive-filter coefficients are inverted at intervals of a period of 160 samples (i.e., at intervals of a period of 20 msec), and a 16-bit binary fixed-point computing unit is used, the estimated value of accumulated arithmetic errors resulting from truncation operations is 160×0.5/32768(=2̂15)=approx. 0.00244. Therefore, optimizing an adaptive filter so as to cause the values of the adaptive-filter coefficients to be distributed as widely as possible within the range between “−1” and “1” enables achievement of a superior convergence characteristic.

Hereinbefore, an example of an embodiment according to the present invention has been described, however, the present invention is not limited to the foregoing embodiment, but various modifications can be made on the basis of technical ideas of the present invention. For example, causing software to execute the foregoing series of processes by installing programs including the software into a computer incorporating dedicated hardware therein can be achieved.

The present application contains subject matter related to that disclosed in Japanese Priority Patent Application JP 2008-235433 filed in the Japan Patent Office on Sep. 12, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An echo cancelling device, comprising:
a filter-coefficient polarity inverter configured to invert the polarity of a filter coefficient at intervals of a predetermined frame length;
an adaptive filter configured to estimate a signal to be inputted from an unknown system by multiplying a signal to be outputted from a speaker by the filter coefficient, and generate the resultant estimated signal;
a subtracter configured to calculate an error signal from an input signal from a microphone and the estimated signal; and
an error-signal polarity inverter configured to invert the polarity of the error signal in synchronization with the inversion of the polarity of the filter coefficient at intervals of the predetermined frame length;
wherein the adaptive filter updates the filter coefficient on the basis of the error signal by using binary fixed-point arithmetic, and therein, performing a truncation operation.

2. The echo cancelling device according to claim 1, further comprising:
an estimated-signal polarity inverter configured to invert the polarity of the estimated signal at intervals of the predetermined frame length;
wherein the subtracter calculates an error signal from the input signal from the microphone and the estimated signal whose polarity is inverted in synchronization with the inversion of the polarity of the filter coefficient at intervals of the predetermined frame length.

3. The echo cancelling device according to claim 1, wherein the adaptive filter is configured to include a large scale integrated (LSI) chip using integer arithmetic.

4. A signal processing device, comprising:
a filter-coefficient polarity inverter configured to invert the polarity of a filter coefficient at intervals of a predetermined frame length;
an adaptive filter configured to estimate a signal to be outputted from an unknown system by multiplying an inputting signal to the unknown system by the filter coefficient, and generate the resultant estimated signal;
a subtracter configured to calculate an error signal from an outputting signal from the unknown system and the estimated signal; and
an error-signal polarity inverter configured to invert the polarity of the error signal in synchronization with the inversion of the polarity of the filter coefficient at intervals of the predetermined frame length;
wherein the adaptive filter updates the filter coefficient on the basis of the error signal by using binary fixed-point arithmetic, and therein, performing a truncation operation.

5. A signal processing method, comprising the steps of:
inverting the polarity of a filter-coefficient at intervals of a predetermined frame length;
generating an estimated signal resulting from estimation of a signal to be outputted from an unknown system by multiplying an inputting signal to the unknown system by the filter coefficient;
performing subtraction to calculate an error signal from an outputting signal from the unknown system and the estimated signal;
inverting the polarity of the error signal in synchronization with the inversion of the polarity of the filter coefficient at intervals of the predetermined frame length; and
updating the filter coefficient on the basis of the error signal by using binary fixed-point arithmetic, and therein, performing a truncation operation.

6. A program configured to cause an information processing device to execute the steps of:
inverting the polarity of a filter-coefficient at intervals of a predetermined frame length;
generating an estimated signal resulting from estimation of a signal to be outputted from an unknown system by multiplying an inputting signal to the unknown system by the filter coefficient;
performing subtraction to calculate an error signal from an outputting signal from the unknown system and the estimated signal;
inverting the polarity of the error signal in synchronization with the inversion of the polarity of the filter coefficient at intervals of the predetermined frame length; and
updating the filter coefficient on the basis of the error signal by using binary fixed-point arithmetic, and therein, performing a truncation operation.
